(19) United States
(12) Patent Application Publication
(10) Pub. No.: US 2013/0297438 A1
(43) Pub. Date: Nov. 7, 2013

(54) SYSTEM AND METHOD FOR PROVIDING BIDDING AND EXECUTION OF FRACTIONAL OWNERSHIP ASSETS

(71) Applicant: Rick Steven Louie, Los Gatos, CA (US)

(72) Inventor: Rick Steven Louie, Los Gatos, CA (US)

(21) Appl. No.: 13/461,849

(22) Filed: May 2, 2012

(51) Int. Cl. G06Q 30/08

(52) U.S. Cl. 705/26.3

(57) ABSTRACT

The present invention generally relates to web based systems for providing and managing investment opportunities. In particular, embodiments of the invention relate to system and method for providing individuals the ability to bid on and invest in fractional ownership of otherwise indivisible real and intellectual property assets. It is an object of the present invention to provide individuals who may otherwise be unable to afford or participate in investments related to property the ability to participate in a fractional ownership of such property and to have ownership rights and utilization rights of the property to be administrated or otherwise identified by components of the system.

### FIELD OF THE INVENTION

The present invention generally relates to web based systems for providing and managing investment opportunities. In particular, embodiments of the invention relate to system and method for providing individuals the ability to bid on and invest in fractional ownership of otherwise indivisible real and intellectual property assets as well as providing management and other investor services with such bidding and investment services.

### BACKGROUND

There exist numerous classes of goods and assets that individual investors and collectors simply are unable to own or invest in by way of being priced out of the market due to the comparatively high prices of these goods and assets. Trophy assets, such as fine art, historically important real estate (e.g., the Empire State Building), sports franchises and collectibles (e.g., rare automobiles), can be extremely expensive and out of the reach of ordinary or typical investors or collectors.

In many cases, these assets are sold at auctions or through bidding processes where the entire asset is, upon completion, transferred to the highest paying individual or company. Most commonly, it is the desire of the seller to reap the highest possible price for the asset and that is accomplished by pitting interested parties against each other in order to raise the price to the maximum the market will bear.

However, these sales or auctions of assets are winner-takes-all arrangements that may leave value on the table as individual investors/buyers may be priced out of the sale prior to reaching the maximum amount of value they would actually pay for the asset. Unfortunately for both the buyer and the seller, the desired buyer's lack of ability to finance their pricing upside means they are excluded from the bidding, even though, given the opportunity, they would pay more.

Additionally, owners of particular assets may not desire to completely release their ownership rights to an asset. However, most auction systems today only provide methods for total sale of an asset. Owners wishing only to sell partial interests in an asset, and have that sale/license of partial interest be limited to transactions reaching or exceeding a certain threshold are simply not available in today's marketplace.

Finally, even where systems are in place that allow for owners of assets to sell their assets via a bidding process, little or no management and control procedures of such process are provided. For instance, if an owner of an asset wishes to sell an asset through a bidding process, the asset is typically listed, described and/or shown and then bidders simply bid for the right to take ownership promptly after the sale.

Therefore, there is need in the art for a system and method for providing individuals the ability to bid on and invest in fractional ownership of otherwise indivisible real and intellectual property assets as well as providing management and other investor services with such bidding and investment services. These and other features and advantages of the present invention will be explained and will become obvious to one skilled in the art through the summary of the invention that follows.

### SUMMARY OF THE INVENTION

Accordingly, it is an aspect of the present invention to provide a system and method for providing individuals the ability to bid on and invest in fractional ownership of otherwise indivisible real and intellectual property assets as well as providing management and other investor services with such bidding and investment services.

According to an embodiment of the present invention, a web-based system for providing bidding and execution of fractional ownership assets includes: an auction management engine comprising computer-executable code stored in non-volatile memory, a data store and an auction management communications means; an asset management engine comprising computer-executable code stored in non-volatile memory, a data store and an asset management communications means; wherein said asset management communications means is configured to communicate data to said auction management communications means; and a communications engine comprising computer-executable code stored in non-volatile memory, a data store and a communications engine communications means, wherein said communications engine communications means is configured to communicate data from said auction management engine and said asset management engine to one or more investors and one or more sellers, wherein said computer-executable code of said auction management engine is configured to perform the steps of: receiving an auction initialization request from one or more sellers; identifying auction parameters from said auction initialization request; generating an asset information identification based at least in part on said auction initialization request; transmitting said asset information identification to said asset management engine; and effecting initiation of an auction process based at least in part on said auction initialization request, wherein said computer-executable code of said asset management engine is configured to perform the steps of: receiving said asset information identification from said auction management engine; identifying one or more assets from said asset information identification; identifying one or more asset types for each of said one or more assets; and effecting receivership of said one or more assets based on said one or more asset types.

According to an embodiment of the present invention, the system further includes a valuation engine comprising computer-executable code stored in non-volatile memory, a data store and a valuation engine communications means, wherein said computer-executable code of said valuation engine is configured to perform the steps of: receiving said asset identification information from said auction management engine; identifying one or more assets from said asset information identification; identifying one or more asset types for each of said one or more assets; generating a valuation for each of said one or more assets based on one or more of an appraisal and an industry expertise; and transmitting said valuation to said auction management engine via said valuation engine communications means.

According to an embodiment of the present invention, the computer-executable code of said auction management engine is further configured to perform the step of setting a maximum valuation of an asset.

According to an embodiment of the present invention, the computer-executable code of said valuation engine is further configured to perform the step of setting a closing deadline on said auction process.

According to an embodiment of the present invention, the computer-executable code of said valuation engine is further configured to perform the step of setting a minimum total investment amount for said auction process.

According to an embodiment of the present invention, the computer-executable code of said valuation engine is further configured to perform the step of setting a maximum total investment amount.

According to an embodiment of the present invention, the computer-executable code of said valuation engine is further configured to perform the step of setting a minimum individual investment amount.

According to an embodiment of the present invention, the computer-executable code of said valuation engine is further configured to perform the step of setting a maximum investment amount.

According to an embodiment of the present invention, the computer-executable code of said valuation engine is further configured to execute the finalization of said auction process upon exceeding a minimum total investment amount prior to passing a closing deadline.

According to an embodiment of the present invention, a web-based method for providing bidding and execution of fractional ownership assets, includes the steps of: receiving, at an auction management engine, an auction initialization request from one or more sellers; identifying, at said auction management engine, auction parameters from said auction initialization request; generating, at said auction management engine, an asset information identification based at least in part on said auction initialization request; transmitting, from said auction management engine, said asset information identification to an asset management engine; identifying, at said asset management engine, one or more assets from said asset information identification; identifying, at said asset management engine, one or more asset types for each of said one or more assets; effecting, at said asset management engine, receivership of said one or more assets based on said one or more asset types; confirming, from said asset management engine, said receivership of said one or more assets to said auction management engine; effecting, at said auction management engine, initiation of an auction process based at least in part on said auction initialization request.

According to an embodiment of the present invention, the web-based method further includes the steps of: receiving, at a valuation engine, said asset identification information from said auction management engine; identifying, at said valuation engine, one or more assets from said asset information identification; identifying, at said valuation engine, one or more asset types for each of said one or more assets; generating, at said valuation engine, a valuation for each of said one or more assets based on one or more of an appraisal and an industry expertise; and transmitting, from said valuation engine, said valuation to said auction management engine.

According to an embodiment of the present invention, the web-based method further includes the step of setting, at said auction management engine, a maximum valuation of an asset.

According to an embodiment of the present invention, the web-based method further includes the step of setting, at said auction management engine, a closing deadline on said auction process.

According to an embodiment of the present invention, the web-based method further includes the step of setting, at said auction management engine, a minimum total investment amount for said auction process.

According to an embodiment of the present invention, the web-based method further includes the step of setting, at said auction management engine, a maximum total investment amount.

According to an embodiment of the present invention, the web-based method further includes the step of setting, at said auction management engine, a minimum individual investment amount.

According to an embodiment of the present invention, the web-based method further includes the step of setting, at said auction management engine, a maximum investment amount.

According to an embodiment of the present invention, the web-based method further includes the step of finalizing, at said auction management engine, said auction process upon exceeding a minimum total investment amount prior to passing a closing deadline.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a network schematic of a system as engaged by various users, in accordance with an embodiment of the present invention;

FIG. 4 is a system diagram, in accordance with an embodiment of the present invention;

FIG. 5 is a process flow of an exemplary method, in accordance with an embodiment of the present invention;

FIG. 6 is a tabular example of a fractional ownership auction in accordance with an embodiment of the present invention;

FIG. 7 is a tabular example of a fractional ownership auction in accordance with an embodiment of the present invention;

FIG. 8 is a tabular example of a fractional ownership auction in accordance with an embodiment of the present invention; and

FIG. 9 is a tabular example of a fractional ownership auction in accordance with an embodiment of the present invention.

### DETAILED SPECIFICATION

The present invention generally relates to web based systems for providing and managing investment opportunities. In particular, embodiments of the invention relate to system and method for providing individuals the ability to bid on and invest in fractional ownership of otherwise indivisible real and intellectual property assets. It is an object of the present invention to provide individuals who may otherwise be unable to afford or participate in investments related to property the ability to participate in a fractional ownership of such property and to have ownership rights and utilization rights of the property to be administrated or otherwise identified by components of the system.

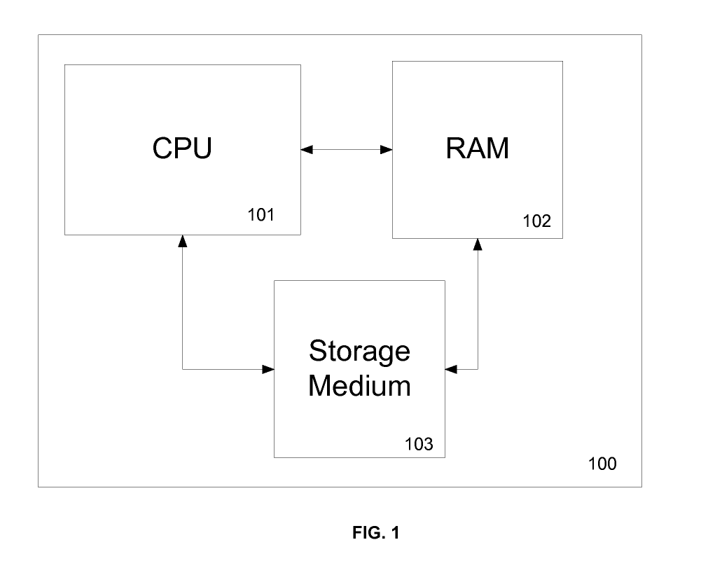

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

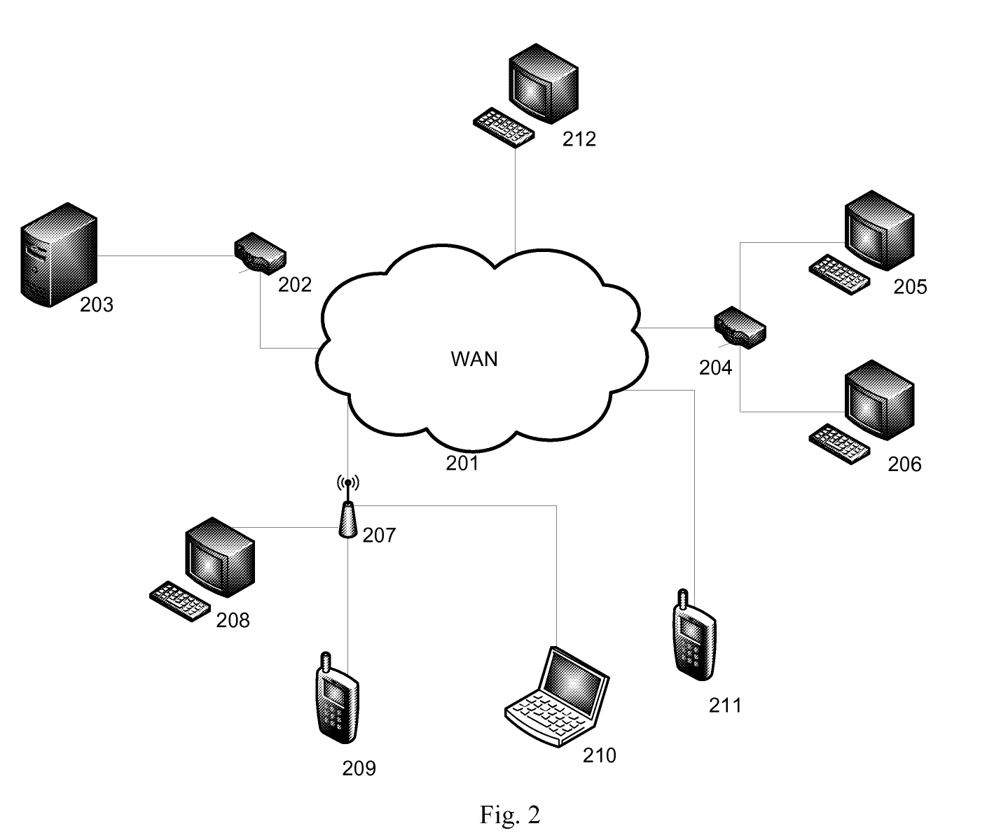

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

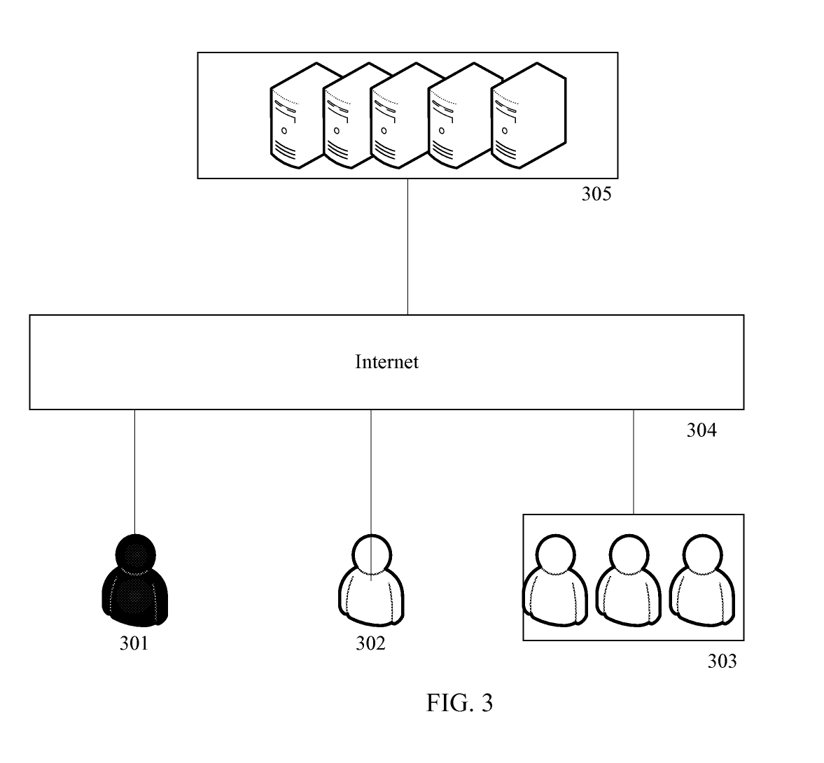

Referring now to FIG. 3, a network schematic of a system as engaged by various users, in accordance with an embodiment of the present invention, is shown. According this preferred embodiment of the present invention, users are separated into two distinct groups. The first group of users is the administrative group 301, which consists of users who administer or otherwise create auctions through the systems and methods provided herein. The second group of users are the bidders, which may consist of individual bidders 302 or group bidders 303. Each of these groups of users will ideally connect to the various components of the system 305 through one or more networks, such as the Internet 304. The functions and methods provided to the administrative group 301 may vary greatly from those provided to the individual bidders 302 and group bidders 304.

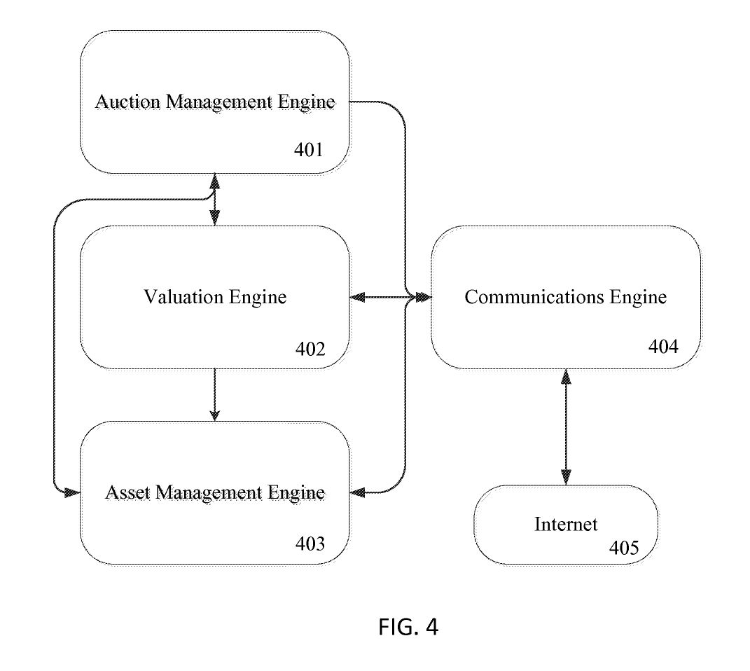

Referring now to FIG. 4, a system diagram, in accordance with an embodiment of the present invention, is shown. In this preferred embodiment, the system is comprised of an auction management engine 401, a valuation engine 402, an asset management engine 403 and a communications engine 404.

According to an embodiment of the present invention, an auction management engine exists on or as part of one or more computing devices and may be further comprised of computer-executable code stored in non-volatile memory, a data store and an auction management communications means. The auction management engine is configured to provide users access to numerous methods and functions for creating, generating, managing and effecting auctions for fractional ownership of otherwise indivisible real and/or intellectual property assets.

The data store of the auction management engine may include any form of computing device capable of storing information and communicating with other computing devices, or may otherwise exist on the same computing device as the auction management engine. For example and without limitation, in embodiments the data store includes a relational database management system, a stream-based database management system, or the like. A variety of suitable database management systems will be readily appreciated. The data store is operatively coupled to the auction management engine.

The data store is configured to store information related to the users of the system and the various auctions that may be presently occurring, currently being setup or have transpired in the past. In a preferred embodiment of the present invention, data stored may include types of auctions that have occurred in the past, financial information related to the auctions/transactions, management information for ongoing fractional ownership contracts and rights and information related to each user, including assets owned and credit limits allowed for auctions. One of ordinary skill in the art would appreciate that there are numerous forms of data that the data store could contain and embodiments of the present invention are contemplated for use with any form of data.

According to an embodiment of the present invention, a valuation engine exists on or as part of one or more computing devices and may be further comprised of computer-executable code stored in non-volatile memory, a data store and a valuation engine communications means. The valuation engine is configured to provide users access to numerous methods and functions for generating valuations, managing valuations and assets and transmitting valuations of assets to one or more other components of the system as needed.

The data store of the valuation engine may include any form of computing device capable of storing information and communicating with other computing devices, or may otherwise exist on the same computing device as the auction management engine. For example and without limitation, in embodiments the data store includes a relational database management system, a stream-based database management system, or the like. A variety of suitable database management systems will be readily appreciated. The data store is operatively coupled to the valuation engine.

The data store is configured to store information related to the valuation of assets. In a preferred embodiment of the present invention, data stored may include types of types of assets, current and former valuations for individual assets or asset classes, subjective valuation analysis from various professionals as well as objective valuation analysis data points automatically, programmatically or manually generated by or provided to the system. One of ordinary skill in the art would appreciate that there are numerous forms of data that the data store could contain and embodiments of the present invention are contemplated for use with any form of data.

According to an embodiment of the present invention, an asset management engine exists on or as part of one or more computing devices and may be further comprised of computer-executable code stored in non-volatile memory, a data store and an auction management communications means. The asset management engine is configured to provide users access to numerous methods and functions for managing, identifying, transferring, providing receivership for, escrowing or otherwise overseeing various assets under the control of one or more users of the system.

The data store of the asset management engine may include any form of computing device capable of storing information and communicating with other computing devices, or may otherwise exist on the same computing device as the asset management engine. For example and without limitation, in embodiments the data store includes a relational database management system, a stream-based database management system, or the like. A variety of suitable database management systems will be readily appreciated. The data store is operatively coupled to the auction management engine.

The data store is configured to store information related to the users of the system and the various assets under control or management by the system as well as formerly managed or controlled assets. In a preferred embodiment of the present invention, data stored may include identification of assets currently or previously in escrow by the system, assets currently or previously in receivership by the system, assets currently or previously managed by the system, information about particular assets and the ownership of such assets and records of transfers of assets to and from the system. One of ordinary skill in the art would appreciate that there are numerous forms of data that the data store could contain and embodiments of the present invention are contemplated for use with any form of data.

According to an embodiment of the present invention, a communication engine exists on or as part of one or more computing devices and may be further comprised of computer-executable code stored in non-volatile memory, a data store and an auction management communications means. The communication engine is configured to provide communications between the various components of the system as well as communications between the system and the various users of the system.

The data store of the communication engine may include any form of computing device capable of storing information and communicating with other computing devices, or may otherwise exist on the same computing device as the communication engine. For example and without limitation, in embodiments the data store includes a relational database management system, a stream-based database management system, or the like. A variety of suitable database management systems will be readily appreciated. The data store is operatively coupled to the auction management engine.

The data store is configured to store information related to the communications between the various components of the system as well as communications with the various users of the system. In a preferred embodiment of the present invention, data stored may include information related to the various communications and provide a record for validation and compliance purposes where necessary, required or desired. One of ordinary skill in the art would appreciate that there are numerous forms of data that the data store could contain and embodiments of the present invention are contemplated for use with any form of data.

According to embodiments of the present invention, the various components of the system are configured to provide users the ability to create and participate in fractional ownership investment transactions. As opposed to traditional auctions and transactions for entire ownership of assets, fractional ownership investment transactions are aimed at providing individuals or groups of individuals the ability to become a partial owner or investor in real or intellectual property they would otherwise not be able to own or invest in. Assets include, but are not limited to, collectibles, artifacts, art work, real estate, sports franchises and historic works. One of ordinary skill in the art would appreciate that there are numerous types of assets that are usable with embodiments of the present invention, and embodiments of the present invention are contemplated for use with any type of asset.

In a preferred embodiment of the present invention, the system is configured to allow a user to start an auction for an asset he/she/it already owns or owns a divisible portion thereof. Prior to executing the auction, the system is configured to allow the user to enter numerous parameters for the auction, including minimum bid size, minimum ownership percentage, maximum ownership percentage, total ownership percentage to auction, specific rights applicable to various ownership percentages and information regarding the asset, including but not limited to, how the asset is held, any valuations of the asset and desired transfer method for the asset. One of ordinary skill in the art would appreciate that there are numerous types of parameters that could be utilized by embodiments of the present invention and embodiments of the present invention are contemplated for use with any parameter.

Prior to executing the auction, the system may be configured to require receivership or other transfer of the asset to be auctioned to the system. This may include the provision of a contractual or other obligation to the system that the asset is owned by the user initiating the auction. In other embodiments, the actual physical transfer of the asset to the system or a physical holding company may be required prior to execution of the auction. In other embodiments, no asset transfer may be required. The more effective the transfer of the asset to the system, the more likely investing users will be to engage in the auction as the system will be able to verify the authenticity, condition and accuracy of the asset and listing.

The system may be configured to handle the auction in any number of formats. For instance, the auction may be conducted silently (i.e., bidders are not aware of other bidders amounts) or openly, for fixed percentages or variable percentage bidding, based on fixed valuations or user definable valuations, with open rights for collective bidding or restricted to individual bidding only. The system may allow a user to set the parameters of the auction prior to the execution of the auction and in some instances allow for the modification of parameters of the auction during an open auction. Auctions may occur in numerous manners as well, including, but not limited to, live, over a specified time period or ongoing.

In certain embodiments of the present invention, the system may be configured to allow the system or some managing company or user to collect a fee for administering or otherwise managing the auction and transfer/receivership of the assets involved. One of ordinary skill in the art would appreciate that there are numerous ways in compensating administrators or managers of auctions, and embodiments of the present invention are contemplated for use with any method for compensating such individuals or companies.

According to an embodiment of the present invention, the system may be configured to allow the user creating an auction to determine how the asset rights are to be divided and exactly what is offered for a given investment. For instance, in the case of real estate, an auction generating user may wish to sell a 50% stake in the real estate and provide that each investor may have the opportunity to enjoy the real estate in equal portion to their purchased ownership percentage, with a minimum ownership stake of 5%. In this embodiment, a user with 5% state would be allowed possession of the property for 18 calendar days per year. Alternatively, the user may be provided continuous access to a designated 5% of the real property (e.g., a suite in a hotel).

With other assets, such as fine art or collectibles, the system may be configured to allow the users to define periods in which possession will be taken by the individual investors. For instance, a famous painting may be held by a group of investors, to be displayed in the homes of such investors for a share of time based on their ownership percentages. One of ordinary skill in the art would appreciate that there are numerous methods for providing access and rights to assets based on a fractional share in accordance with embodiments of the present invention, and embodiments of the present invention are contemplated for use with any method for providing access and/or rights to assets based on such fractional shares.

### Exemplary Embodiments

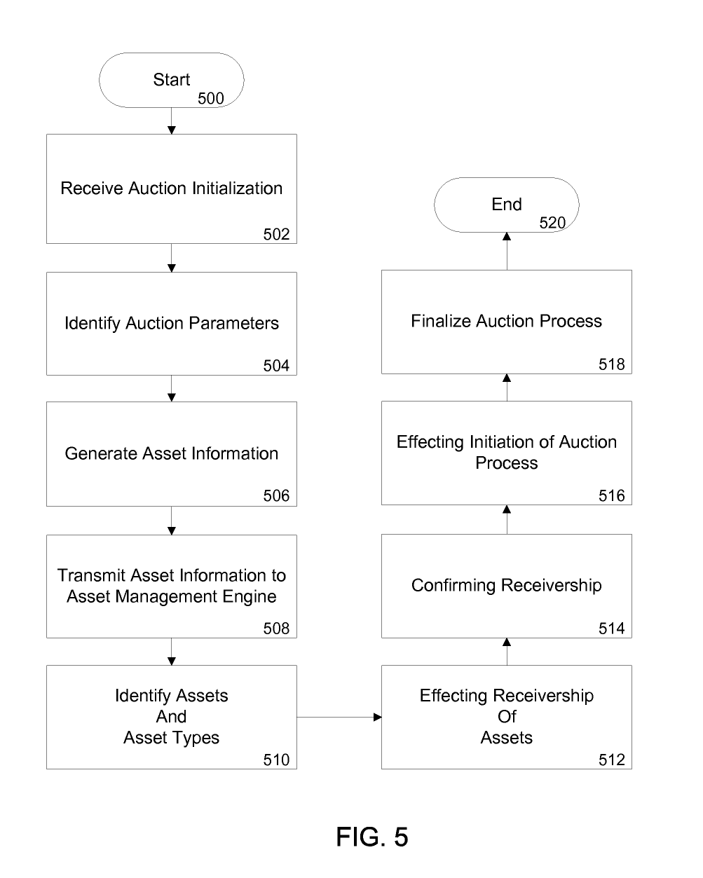

Turning now to FIG. 5, a flowchart of an exemplary method in accordance with an embodiment of the present invention is shown. At step 500, the process starts. At step 502, the system received an auction initialization request from a user. In general, the auction initialization request is received at the communications engine and transferred to the auction management engine for processing. In an exemplary embodiment, the auction initialization request will contain all the information regarding the user, the auction and the assets associated with the auction required by the system to effect the auction. If information is missing, the system can query the user for additional required information.

At step 504, The auction management engine has received the auction initialization request and identifies the parameters associated with the auction. Again, as noted in Step 504, if there is information or parameters missing, or otherwise invalid parameters, the system may be configured to request additional information from the user.

At step 506, the system extracts all the information in the auction initialization request related to the asset to be auctioned and generates an asset information identification. In a preferred embodiment, this identification is a formatted data object that is configured to be passed to the asset management engine for processing. The format is utilized to standardize the transfer of asset information between the various components of the system.

At step 508, The auction management engine transmits the asset information identification to the asset management engine for processing.

At step 510, The asset management engine identifies the assets for the auction through the asset information identification provided by the auction management engine. The identification may include valuations, asset types, asset classes, ownership percentages, how/where the asset is to be received/escrowed or otherwise secured during the auction process and any other relevant information regarding the one or more assets to be auctioned.

At step 512, the system is configured to utilize the asset management engine to effect receivership or other transfer of the assets for security purposes during the auction. Transfer may include contractual transfers, receipt of original deeds or the asset itself (especially in the case of rare collectibles or fine artwork) or the receipt of a promissory note or other executed agreement for the purpose of securing the asset.

At step 514, the asset management engine confirms the validity and/or the receipt/receivership of the assets in a manner acceptable to the system. The acceptability of the receipt of an asset may depend on the class of the asset, the value of the asset and the type of auction that is to occur.

At step 516, The asset management engine has confirmed receivership of the asset and confirms the receipt to the auction management engine. The auction management engine then initiates the auction under the parameters identified by the user and other relevant variables. Other users of the system are then provided the ability to participate in the auction under the guiding parameters previously defined for the auction.

At step 518, the auction is finalized. This may include a successful auction of one or more assets, whereby fractional ownership and the rights therein are transferred to the various new owners of the assets. Further, the system is configured to provide documents or other administrative functions (e.g., processing of payments) in order to effect and finalize the legal aspects or administrative aspects of the fractional ownership investments. This step may also include the processing of how the fractional ownership percentages are aligned and issued (as will be described below). Finally, at Step 520, the process terminates.

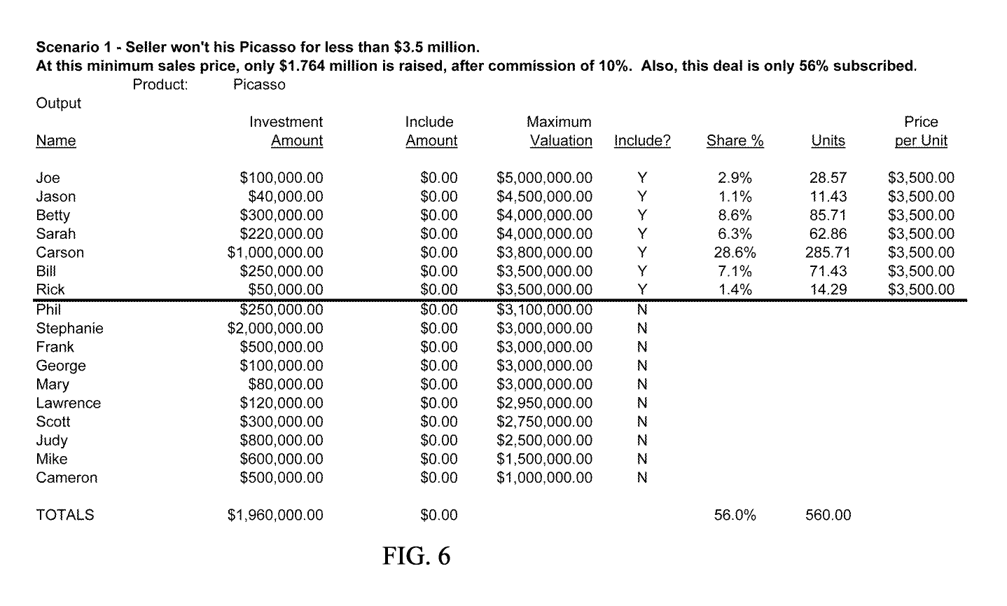

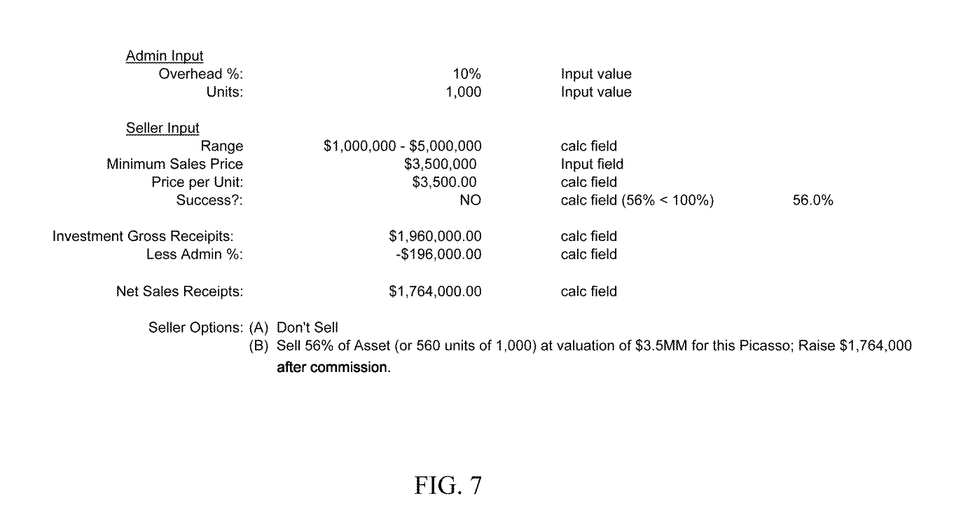

Turning now to FIGS. 6-9, two examples of fractional ownership auctions, in accordance with embodiments of the present invention, are shown. In FIGS. 6-7, a Picasso is being sold, where the sale price is set at a minimum of $3.5 million. Only those bidders who have included a valuation of over $3.5 million are included in the final outcome of the auction and since the auction did not meet the required subscription level, the auctioning user has the ability to decide whether he wishes to accept the sale of a fractional ownership of his Picasso equal to 56% ownership or reject the entire auction as a failure to meet set subscription levels.

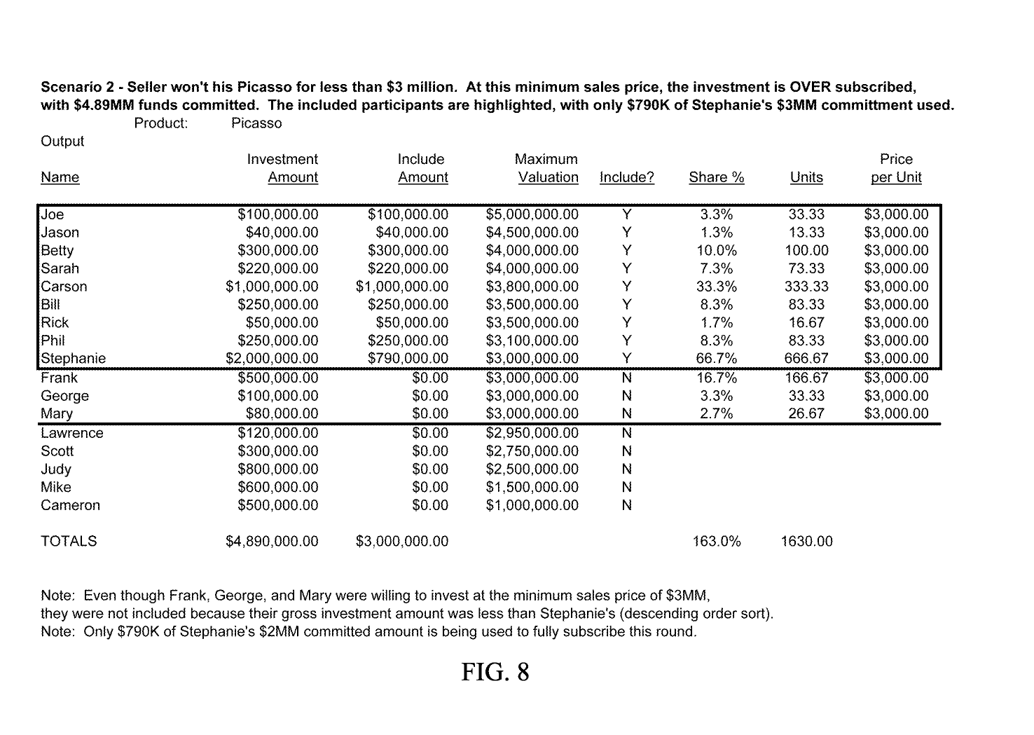

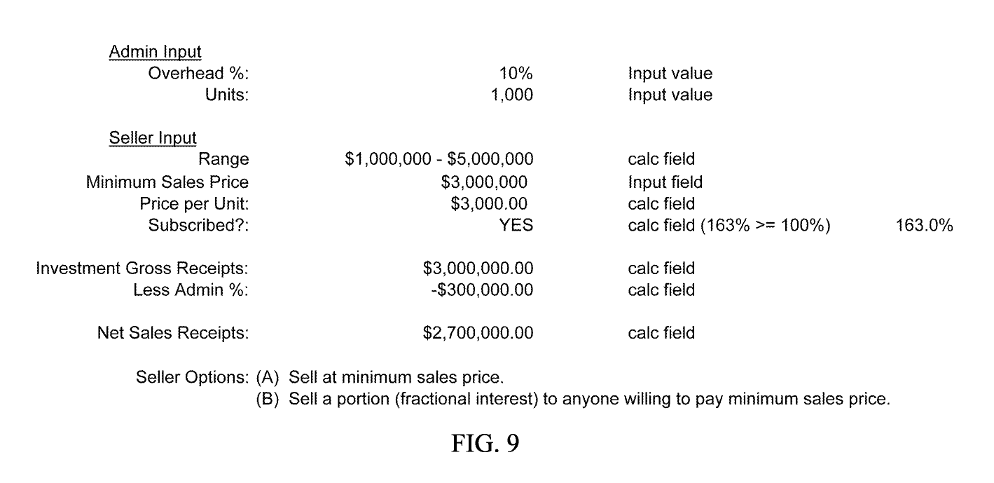

In FIGS. 8-9, a Picasso is being sold, where the sale price is set at a minimum of $3.0 million. Only those bidders who have included a valuation of over $3.0 million are included in the final outcome of the auction and since the auction was over the desired subscription level (100% sale of ownership), the auctioning user is required to affirm the transaction as the sale has met the minimum sale price.

While both of the above auction examples are based on a minimum sale price, there are several other auction types that can be utilized with embodiments of the system (as described above). One of ordinary skill in the art would appreciate that there are numerous auction types that may be used in accordance with embodiments of the present invention, and embodiments of the present invention are contemplated for use with any manner of auction type.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for providing bidding and execution of fractional ownership assets, the system comprising:
an auction management engine comprising computer-executable code stored in non-volatile memory, a data store and an auction management communications means;
an asset management engine comprising computer-executable code stored in non-volatile memory, a data store and an asset management communications means;
wherein said asset management communications means is configured to communicate data to said auction management communications means; and
a communications engine comprising computer-executable code stored in non-volatile memory, a data store and a communications engine communications means,
wherein said communications engine communications means is configured to communicate data from said auction management engine and said asset management engine to one or more investors and one or more sellers,
wherein said computer-executable code of said auction management engine is configured to perform the steps of:
receiving an auction initialization request from said one or more sellers;
identifying auction parameters from said auction initialization request;
generating an asset information identification based at least in part on said auction initialization request;
transmitting said asset information identification to said asset management engine; and
effecting initiation of an auction process based at least in part on said auction initialization request,
wherein said computer-executable code of said asset management engine is configured to perform the steps of:
receiving said asset information identification from said auction management engine;
identifying one or more assets from said asset information identification;
identifying one or more asset types for each of said one or more assets;
and
effecting receivership of said one or more assets based on said one or more asset types.

2. The web-based system of claim 1, further comprising a valuation engine comprising computer-executable code stored in non-volatile memory, a data store and a valuation engine communications means, wherein said computer-executable code of said valuation engine is configured to perform the steps of:
receiving said asset identification information from said auction management engine;
identifying one or more assets from said asset information identification;
identifying one or more asset types for each of said one or more assets;
generating a valuation for each of said one or more assets based on one or more of an appraisal and an industry expertise; and
transmitting said valuation to said auction management engine via said valuation engine communications means.

3. The web-based system of claim 1, wherein said computer-executable code of said auction management engine is further configured to perform the step of setting a maximum valuation of an asset.

4. The web-based system of claim 1, wherein said computer-executable code of said valuation engine is further configured to perform the step of setting a closing deadline on said auction process.

5. The web-based system of claim 1, wherein said computer-executable code of said valuation engine is further configured to perform the step of setting a minimum total investment amount for said auction process.

6. The web-based system of claim 1, wherein said computer-executable code of said valuation engine is further configured to perform the step of setting a maximum total investment amount.

7. The web-based system of claim 1, wherein said computer-executable code of said valuation engine is further configured to perform the step of setting a minimum individual investment amount.

8. The web-based system of claim 1, wherein said computer-executable code of said valuation engine is further configured to perform the step of setting a maximum investment amount.

9. The web-based system of claim 1, wherein said computer-executable code of said valuation engine is further configured to execute the finalization of said auction process upon exceeding a minimum total investment amount prior to passing a closing deadline.

10. A web-based method for providing bidding and execution of fractional ownership assets, the method comprising the steps of:
receiving, at an auction management engine, an auction initialization request from one or more sellers;
identifying, at said auction management engine, auction parameters from said auction initialization request;
generating, at said auction management engine, an asset information identification based at least in part on said auction initialization request;
transmitting, from said auction management engine, said asset information identification to an asset management engine;
identifying, at said asset management engine, one or more assets from said asset information identification;
identifying, at said asset management engine, one or more asset types for each of said one or more assets;
effecting, at said asset management engine, receivership of said one or more assets based on said one or more asset types;
confirming, from said asset management engine, said receivership of said one or more assets to said auction management engine;
effecting, at said auction management engine, initiation of an auction process based at least in part on said auction initialization request.

11. The web-based method of claim 10, further comprising the steps of:
receiving, at a valuation engine, said asset identification information from said auction management engine;
identifying, at said valuation engine, one or more assets from said asset information identification;
identifying, at said valuation engine, one or more asset types for each of said one or more assets;
generating, at said valuation engine, a valuation for each of said one or more assets based on one or more of an appraisal and an industry expertise; and
transmitting, from said valuation engine, said valuation to said auction management engine.

12. The web-based method of claim 10, further comprising the step of setting, at said auction management engine, a maximum valuation of an asset.

13. The web-based method of claim 10 further comprising the step of setting, at said auction management engine, a closing deadline on said auction process.

14. The web-based method of claim 10, further comprising the step of setting, at said auction management engine, a minimum total investment amount for said auction process.

15. The web-based method of claim 10, further comprising the step of setting, at said auction management engine, a maximum total investment amount.

16. The web-based method of claim 10, further comprising the step of setting, at said auction management engine, a minimum individual investment amount.

17. The web-based method of claim 10, further comprising the step of setting, at said auction management engine, a maximum investment amount.

18. The web-based method of claim 10, further comprising the step of finalizing, at said auction management engine, said auction process upon exceeding a minimum total investment amount prior to passing a closing deadline.
